(19) United States
(12) Patent Application Publication
(10) Pub. No.: US 2005/0094328 A1
(43) Pub. Date: May 5, 2005

(54) Electrical power connector

(76) Inventors: John Weiss, Oakdale, NY (US); Kuang Pu Liao, Chidu Keelung (TW)

Correspondence Address: FRISHAUF, HOLTZ, GOODMAN & CHICK, PC, 767 THIRD AVENUE, 25TH FLOOR, NEW YORK, NY, 10017-2023, US

(21) Appl. No.: 10/965,308

(22) Filed: Oct. 14, 2004

Related U.S. Application Data
(60) Provisional application No. 60/511,377, filed on Oct. 14, 2003.
(60) Provisional application No. 60/511,378, filed on Oct. 14, 2003.

(51) Int. Cl. H02H 3/00

(52) U.S. Cl. 361/2

(57) ABSTRACT

An alternating electrical power connector uses a control circuit to drive a solid state switch controlling power to an appliance without the possibility of arcing, the control circuit is configured to use very low power and operates without generating heat by providing control current only at the zero crossing.

### FIELD OF THE INVENTION

The invention relates to electrical power plugs and receptacles that prevent arcing when contact engagement is not sufficient to carry current.

### BACKGROUND INFORMATION

Line voltage electrical connectors are susceptible to failure due to arcing when the contact between live parts is insufficient to carry the current. Over time the arcing between mating connectors will degrade the contacts and carbon residue will form a high resistance that may result in heat and fire.

One approach to overcome this problem is to employ a control circuit that couples to the power mains after sufficient engagement of the high current carrying contacts is made. The control circuit provides a small current to a thruster or solid state switch such as a triac so that only after the proper engagement is made, full power is applied. U.S. Pat. No. 4,853,823 (Arechavaleta et al.) discloses an electrical receptacle that senses the full contact engagement with a momentary switch to close a control circuit to provide gate current to a triac that then conducts full load current. U.S. Pat. No. 4,995,017 (Sellati et al.) discloses a second set of contacts within a receptacle to close the control circuit and likewise supplies the triac gate current. Another similar approach is disclosed in U.S. Pat. No. 4,346,419 (Janniello) which uses a resistive path in the control circuit. These approaches cannot supply control current at the zero crossing. Thus current is supplied at some phase angle past the zero crossing requiring excessive control current that is dissipated in the form of heat within the control circuit resistor. A non-continuous current results in a noisy power supply for the appliance to be powered.

### OBJECTS AND SUMMARY OF THE INVENTION

An electrical connector includes a control circuit for driving a solid state switch such as a triac. The control circuit supplies ample current only at the zero crossing for a short duration of the AC cycle. In one embodiment a current limiting resistor and capacitor are employed in the control circuit to provide a phase shift to drive the triac. Once conduction occurs the control circuit is shorted so that no current is conducted to the triac gate and thus the control circuit does not heat excessively even in high current applications.

It is an object of the invention to prevent arcing in an alternating current power connector which limits the heat generated in doing so.

It is a further object of the invention to have an anti-arcing circuit that operates with minimal power and maximum efficiency.

It is yet a further object of the invention to have an anti-arcing connector that provides zero phase switching “clean” AC power to an appliance.

### BRIEF DESCRIPTION OF THE DRAWINGS

FIG. 1 is a circuit schematic of the present invention for a heating pad having a resistive load.

FIG. 1A is a circuit diagram of the present invention including a three position switch.

FIG. 2 is a cross-sectional view of a connector that contains the components in a plug and receptacle of a disconnectable heating pad.

FIG. 3 is a circuit diagram of the present invention for an inductive load.

FIG. 4 is a cross-sectional view of an appliance plug for the electrical anti-arcing circuit of the present invention.

FIG. 5 is an AC waveform for illustrating the electrical characteristics of the anti-arcing circuit.

FIG. 6 is a circuit diagram of the load and connector for the present invention where a micro control is used in the control circuit.

FIG. 7 is a circuit diagram of a control that is used in conjunction with the connector of FIG. 6.

### DETAILED DESCRIPTION

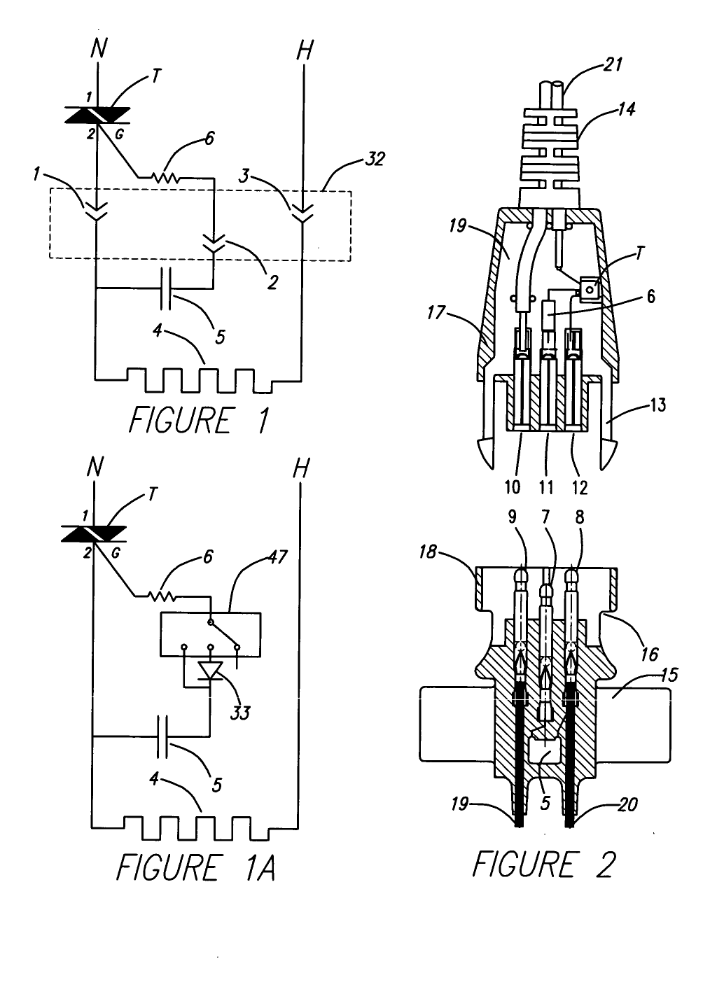

Referring to FIG. 1, a preferred embodiment of the invention will now be discussed. The load 4 is a resistance heating wire commonly used in heating pads. The power is switched on by a solid-state switch such as a triac, T, and is actively switched on every half cycle of a 60 Hertz 120 volt alternating current power source. The heating wire 4 has a resistance of 300 ohms and is 48 watts under full power. The triac T has a 1 amp rating and is preferably of the sensitive gate type requiring only 5 mA to turn on when supplied at the zero crossing of the AC supply voltage. The triac is shown on the neutral side of the supply. An alternate configuration with the triac on the hot, 120 VAC, side is also suitable. The heating pad controller, not shown, also switches the power on the neutral polarity. When 120 VAC is applied between the supply N and H, the power is not instantly turned on until sufficient gate current is introduced to the triac control gate TG which will occur at the next zero crossing, within 1/120th of a second. The gate current is supplied by the series circuit of the control resistor 6, the control capacitor 5 and the load resistance 4. With the arrangement of the capacitor in the control circuit, a phase shift is introduced so that at the zero crossing, when the supply voltage is nearly zero, an ample current is available to the triac gate TG. The triac anode T1 is connected to the supply neutral conductor and the triac cathode T2 is connected to the junction of the control capacitor 5 and the neutral side of the heating wire 4.

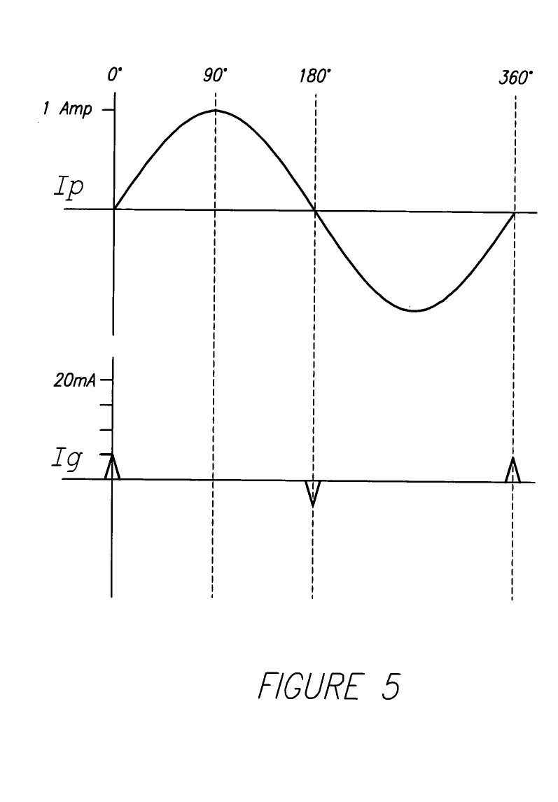

Referring to FIG. 5 it can be seen that the gate current Ig only exists for a short duration when the load current Ip is near zero which occurs at zero and 180 degrees phase angle. Once the gate current is supplied and the triac conducts, the load current is sufficient to hold the triac on until the next zero crossing when the gate current is again provided to trigger the triac for the next half cycle. In this arrangement, the load carries the small gate control circuit until the triac conducts, and the load current is diverted around the gate current, which drops to zero. Conduction effectively shorts the control capacitor 5 and the resistor 6 and the power is all on the load 4. With the control capacitor 5 and the control resistor 6 shorted for a substantial part of the power cycle, the control components, especially the resistor 6, remain very cool. Connector pins are included at the junctions 1, 2 and 3 within a connector 32 to enable the heating pad to be disconnected from the power for laundering. When connection 2 is disconnected, the control current is interrupted and the triac cannot be switched on. The control current is limited by the capacitor 5 and the resistor 6 to a 5 mA current for a brief period and is conducted through the disconnect at 2. Therefore no arcing or hazardous condition arises as a result of the circuit opening. Table 1 lists the component values used when the arc prevention circuit of FIG. 1 is used in a disconnectable heating pad as described herein.

TABLE 1

| Component | Type | Description | Rating |
|---|---|---|---|
| T | Triac | Teccor L601E3 | 1 amp |
| 6 | Resistor | 120 ohm | ⅛ watt |
| 5 | Capacitor | .047 uF | 400 volt |

Referring now to FIG. 1A, the triac gate control circuit is expanded to include a three position switch 47 that is used both for turning the power on and for heat control. In a first position, the control circuit is open, no current drives the triac gate, and the power to the heating pad is off. In a middle switch position, the current is switched to the gate through a diode 33, only for ½ cycle, and the resulting power to the heating pad is half of full power. In a third position the control circuit operates the triac for the full cycle and full power is provided to the heating pad. The switch is a low current slide switch where the first position is off, the second position is for the “Low” temperature setting and the third position is for the “High” temperature setting.

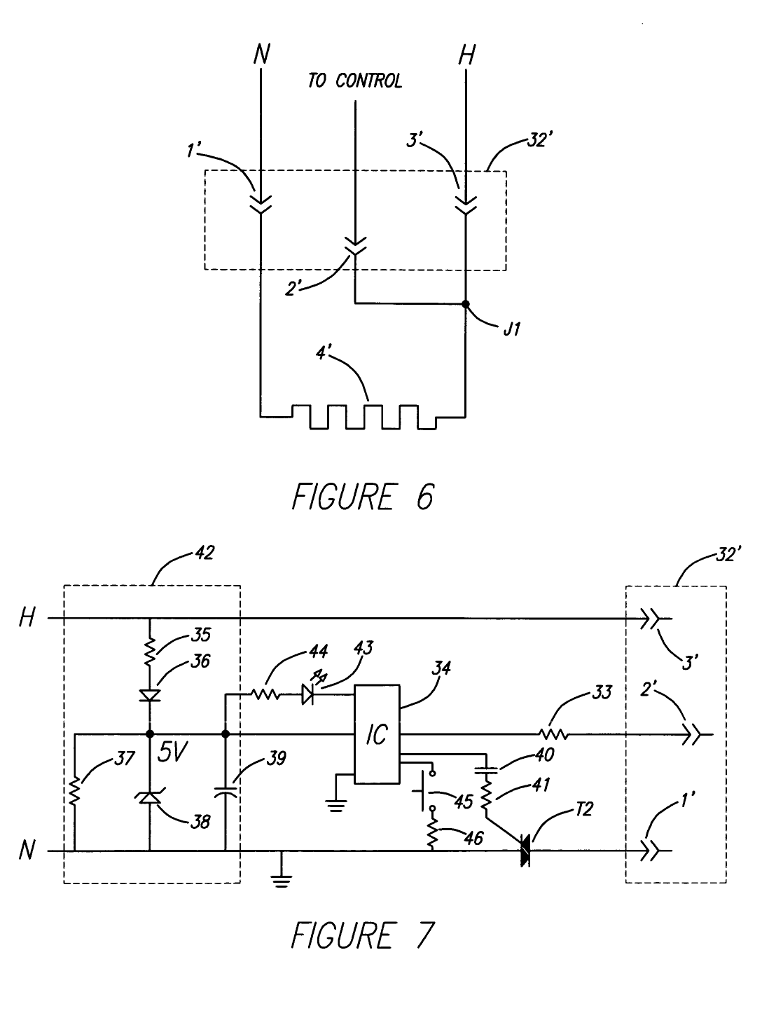

To prevent arcing in the disconnect connector, a control pin at the junction of the control capacitor 5 and the control resistor 6 is shorter than the power connector pins at junction 1 and 3 (shown in FIG. 1). A drawing of the connector is shown in FIG. 2. The short pin 7 is the last connection to engage and the first connection to disengage to the pin socket 11 when connecting the power to the heating pad. The longer pins 8 and 9 will have a minimum engagement to the socket receptacles 10 and 12 before the control circuit is engaged. Electrical connections are made to the connector pins and sockets by crimping to the heater wire ends 19 and 20 and to the hot side of the supply wire 21. The components T, 6 and 5 are attached as shown by soldering and crimping together and to the pins and sockets. The triac T, resistor 6, female sockets 10, 11 and 12 and the supply wire 21 are attached to an internal structure 19 by snap or press fit. This structure 19 is molded of a rigid plastic such as Nylon, glass filled, and includes spring clips 13 on each side. The internal structure is over molded with PVC to enclose and seal the components and to provide a strain relief 14 to the supply wire. Similarly the pins 7, 8 and 9 and the capacitor 5 and the heater wire ends 19 and 20 are over molded with PVC. The enclosure shape includes a shroud 18 and spring clip lock section 16 and pad attachment tabs 15. The spring clips 13 and lock section 16 is provided so that unintentional disconnect is avoided even though a partial disconnect does not present a safety problem.

Where a micro controller is used to monitor or control the appliance, the electrical components within the connector can be replaced by the function of the controller as shown in FIG. 6 and FIG. 7. The connector, schematically shown within the dashed outline 32′ has a neutral pin and socket 1′, an opposite polarity 120 VAC pin and socket 3′, and a short return pin and socket 2′ similar to the pin configuration in the previous example 32. The high voltage is returned through the short control pin and socket 2′ to the control so that engagement of the control pin assures a minimum engagement of the power connections 1′ and 3′.

A simplified version of the control is shown in FIG. 7. The high voltage return signal is connected to an input port of the micro controller 34 with a current limiting resistor 33. This signal is also used by the micro control as the zero cross signal for determining the timing of the output drive signal to the gate of the triac T2 now within the controller. A more elaborate circuit to convert the input sine wave to a square wave, not shown, can be used where more precise timing is required. The output power drive signal is capacitively coupled to the gate of the triac T2 with a capacitor 40 and current limited with resistor 41 in a manner known to those skilled in the art. In order for the triac T2 to conduct, a pulsed gate signal needs to be present. The micro control logic reads the zero cross signal and times the triac drive at zero and 180 degrees phase angle to minimize power consumption and noise. Without the detection of the zero cross signal the control does not drive the triac T2. The micro controller is powered by a low voltage supply circuit shown outlined within 42 comprising a power resistor 35, rectifier diode 36, and with a voltage regulator comprising zener diode 38 resistor 37 and capacitor 39 to provide a steady 5 volt DC source to power the micro controller 34. A momentary switch 45 and current limiting resistor 46 is used to signal the micro controller to turn on or off and an LED indicator 43. Current limiting resistor 44 is used to indicate the active condition of the control and to indicate the engagement of the connector.

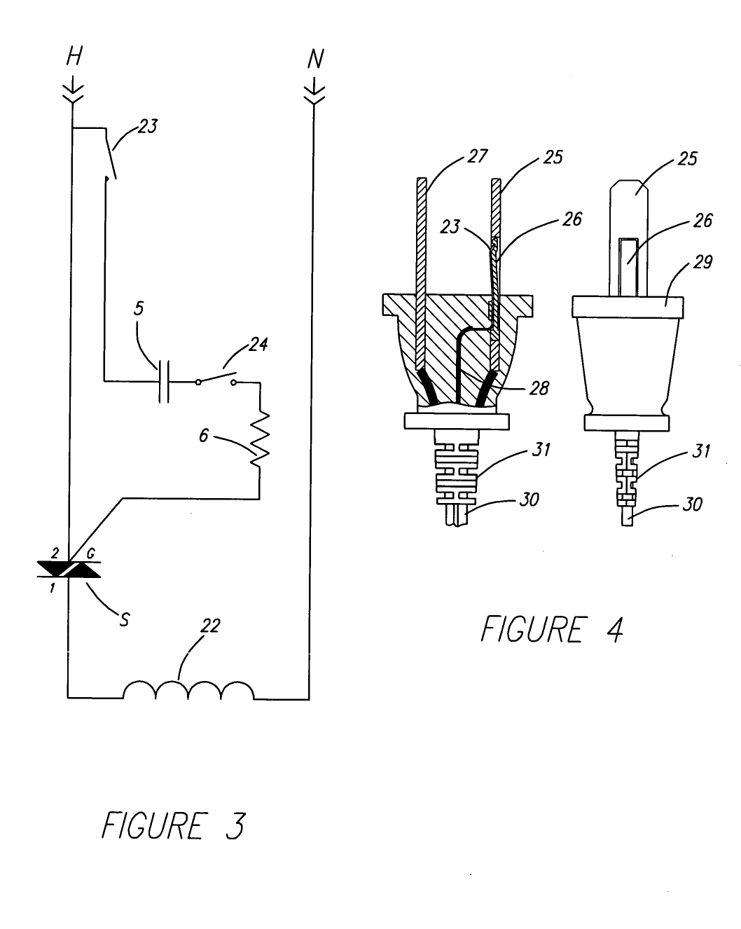

In an alternate embodiment the circuit of the present invention is configured for connecting an appliance that has an inductive load. An example is a vacuum cleaner with a power control and arc prevention circuit. FIG. 3 describes the electrical circuit and FIG. 4 shows the power cord plug for this example. Referring now to FIG. 3 and FIG. 4, a solid state switch S is used for the power switching, similar to the triac described in the previous embodiment. The solid state switch is an alternistor and is made particularly to handle inductive loads such as transformers and motors. A low current on/off switch 24 is included in the control circuit and replaces the high current power switch used in most vacuum cleaners (vacuum cleaners often have a switch on the handle that is used to turn the power on or off). The cord to a low power switch can be smaller, more flexible and easier to conceal. In addition the power control from the low current control circuit will result in a longer life for the switch and the clean zero-crossing switching will also improve the life and reliability of the motor. A contactor 23 is built in to one blade of a wall outlet plug and makes contact to the wall outlet receptacle after a minimum engagement of the blade 25 is already made. The contactor is a thin copper alloy strip that is secured to a plastic bracket 26. The bracket is located in a cutout in the blade 25 and is secured to the plug assembly by molding in place along with the opposite polarity blade 27 and power cord 30. A strain relief 31 is formed as a part of the shape of the PVC plug casing 29. The contactor 23 is attached to a control conductor 28 and returned to the control circuit within the appliance. Once the plug is engaged to the point of enabling the contactor 23 to connect to the power and when the power switch on the control circuit is closed, the vacuum cleaner is under power.

The control capacitor 5, the control resistor 6 and the alternistor are located inside of the vacuum cleaner. In this way the zlternistor can be attached to an appropriately sized heat sink. A third conductor in the power cord is used to connect the control circuit to power.

Table 2 lists the components for the high power inductive type of appliance such as the household vacuum cleaner explained above.

TABLE 2

| Component | Type | Description | Rating |
|---|---|---|---|
| S | Alternistor | Teccor Q4016LH3 | 400 volts |
| 5 | Capacitor | .33 uF film capacitor | 400 volts |
| 6 | Resistor | 1000 ohm | ¼ Watt |

For this application of the present invention consider a situation where a housewife, or house husband, is vacuuming a rug and the power cord is extended and catches on a couch or a piece of furniture pulling the plug from the outlet. First the contactor 23 disconnects and within 120th of a second the alternistor S ceases to conduct, no arcing from the plug can occur.

Two examples of the low power arc prevention circuits and the descriptions of two applications of the invention have been presented, the application of the principles of the invention will become apparent to those skilled in the art. No limitations are implied herein, other than those of the following claims.

1. An electrical connector for connecting and disconnecting an alternating source of electric power to an appliance, said electrical connector providing full power to said appliance when substantial engagement of power connections between said electrical connector and said appliance are made to prevent arcing, said electrical connector comprising:
a first power conductor which connects and disconnects to the appliance;
a second power conductor having a polarity substantially opposite to said first power conductor, said second power conductor connecting and disconnecting to the appliance;
a control connection and disconnection device;
a low power control circuit activated by the connection to said control connection to provide control of a solid state switch to one of the said power conductors only after said first and second power connections are substantially engaged.

2. The electrical connector as defined by claim 1 wherein the said low power control circuit and said solid state switch are disposed within said electrical connector.

3. The electrical connector as defined by claim 2 further comprising a capacitor disposed in said control circuit to provide current to said solid state switch at a zero crossing.

4. The electrical connector as defined by claim 2 further comprising a current limiting resistor.

5. The electrical connector as defined by claim 1 further comprising:
a first housing attached to the supply wire,
a second housing attached to said appliance,
means for mating said first and second housing to provide engagement upon connection of said power connections before said control connection; wherein said control circuit is contained within said first and second housings.

6. An electrical connector for connecting and disconnecting an alternating source of electric power to an appliance, said electrical connector providing full power to said appliance when substantial engagement of power connections are made to prevent arcing, said electrical connector comprising:
an appliance control having a switchable power;
a first power conductor which connects and disconnects said electrical connector from said appliance;
a second power conductor having a polarity opposite to the polarity of said first conductor, said second power conductor connecting and disconnecting said electrical connector from said appliance;
a control connection and disconnection device;
a supply and control cord having a first and second power conductor of opposite polarities and a return conductor, said return conductor being electrically connected to said control connection,
wherein said control connection is electrically coupled to one of said first and second power conductors on the appliance side of said power connector,
and wherein said return conductor activates a control circuit within said appliance control to provide power to the appliance.

7. The electrical connector as defined by claim 6 further comprising a microprocessor.

8. The electrical connector as defined by claim 7 wherein said return conductor is the input of a zero cross circuit input to said microprocessor.

9. The electric connector as defined by claim 8 further comprising a triac and a triac control circuit with a capacitor in series with the gate of said triac.
